(19) United States
(12) Patent Application Publication
(10) Pub. No.: US 2012/0023670 A1
(43) Pub. Date: Feb. 2, 2012

(54) PERSON-SUPPORT APPARATUS INDICATOR

(76) Inventors: Robert M. Zerhusen, Cincinnati, OH (US); Richard H. Heimbrock, Cincinnati, OH (US)

(21) Appl. No.: 13/195,411

(22) Filed: Aug. 1, 2011

Related U.S. Application Data
(60) Provisional application No. 61/369,394, filed on Jul. 30, 2010.

(51) Int. Cl. A47C 31/00; F21V 33/00; A47C 21/08

(52) U.S. Cl. 5/600; 5/425; 5/428; 362/130

(57) ABSTRACT

A siderail assembly comprises a siderail body and an indicator. The siderail body includes a handle configured to be gripped by a person. The indicator is configured to emit light to identify the location of the handle.

This application claims priority to U.S. Provisional Application Ser. No. 61/369,394 titled PERSON-SUPPORT APPARATUS INDICATOR filed on Jul. 30, 2010, the contents of which are incorporated herein by reference.

### BACKGROUND OF THE DISCLOSURE

This disclosure relates generally to person-support apparatuses. More particularly, but not exclusively, one illustrative embodiment relates to an identifying element configured to identify a feature and/or function of the person-support apparatus.

Person-support apparatuses can include many features and can be capable of performing many functions. Some of the features and/or functions of the person-support apparatus might not be readily identifiable, for example, in low light conditions. While various person-support apparatuses have been developed, there is still room for improvement. Thus a need persists for further contributions in this area of technology.

### SUMMARY OF THE DISCLOSURE

One illustrative embodiment of the present disclosure can include a siderail with an indicator configured to emit light to identify the location of a handle. Another illustrative embodiment of the present disclosure can include a frame with a deck and an indicator configured to identify the edge of a person-support surface supported on the deck. Another illustrative embodiment of the present disclosure can include a frame with a deck and an indicator configured to identify the location of a portion of the deck. Another illustrative embodiment of the present disclosure can include an egress handle with an indicator configured to indicate when the person-support apparatus is in a chair configuration. Another illustrative embodiment of the present disclosure can include a frame with a pedal coupled thereto and an indicator configured to identify the location of the pedal.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective side view of a person-support apparatus with siderails coupled to a frame of the person-support apparatus according to one illustrative embodiment;

FIG. 2 is a perspective side view of the person-support apparatus of FIG. 1, showing the grip and the seat section of the deck with an indicator thereon.

FIG. 3 is a perspective side view of the grip of FIG. 2.

FIG. 4 is a perspective side view of the grip portion of the siderail of FIG. 1 showing a partially exploded grip with a translucent cover and a circuit board with an indicator thereon.

FIG. 5 is a partial diagrammatic view of the person-support apparatus of FIG. 1 showing the control system configured to receive signals from various sensors and control the at least one function of the person-support apparatus and the indicator in accordance therewith.

FIG. 6 is a perspective side view of the person-support apparatus of FIG. 1 in the chair configuration with siderails including grips according to another illustrative embodiment.

FIG. 7 is a perspective side view of the siderail and grip of FIG. 6.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure can include a siderail with an indicator configured to emit light to identify the location of a handle. Another illustrative embodiment of the present disclosure can include a frame with a deck and an indicator configured to identify the edge of a person-support surface supported on the deck. Another illustrative embodiment of the present disclosure can include a frame with a deck and an indicator configured to identify the location of a portion of the deck. Another illustrative embodiment of the present disclosure can include an egress handle with an indicator configured to indicate when the person-support apparatus is in a chair configuration. Another illustrative embodiment of the present disclosure can include a frame with a pedal coupled thereto and an indicator configured to identify the location of the pedal.

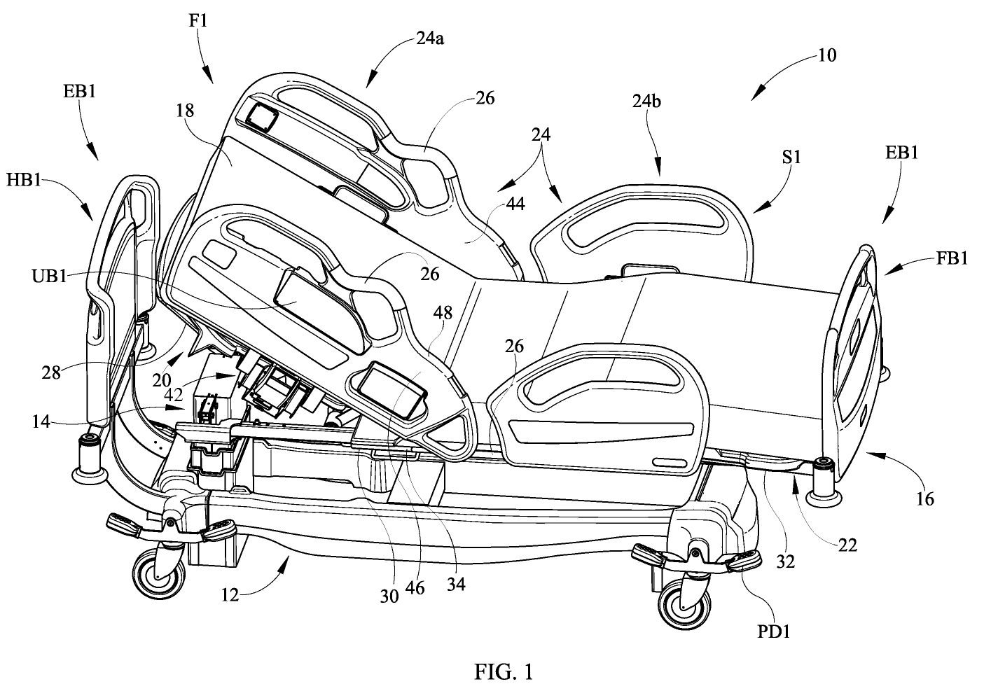

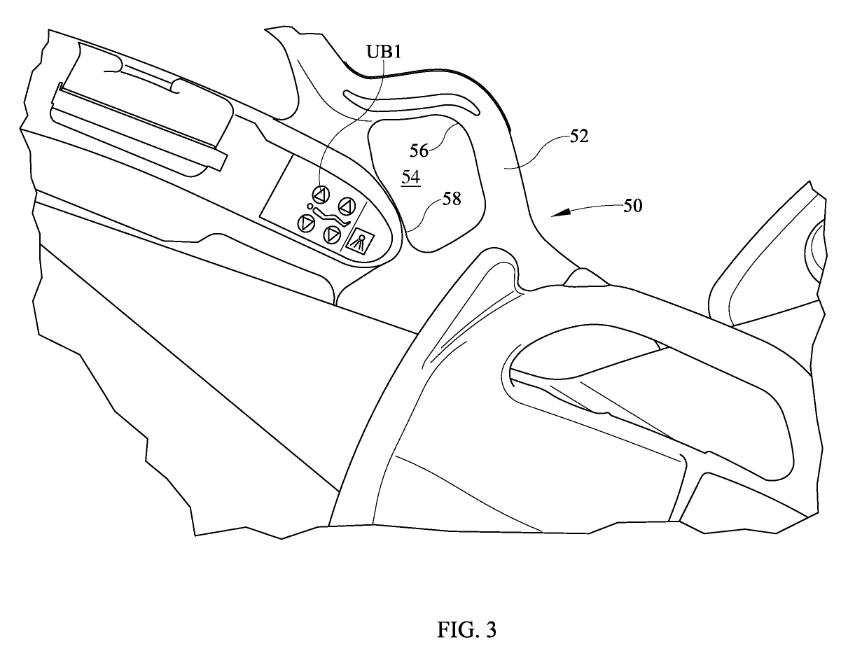

A person-support apparatus 10 according to one illustrative embodiment of the current disclosure is shown in FIGS. 1-5. The person-support apparatus 10 can have a first section F1 or head support section F1, where the head of a person can be positioned and a second section S1 or a foot support section S1, where the feet of the person can be positioned. In one illustrative embodiment, the person-support apparatus 10 can be a hospital bed. In some contemplated embodiments, the person-support apparatus 10 can also be a hospital stretcher or an operating table. The person-support apparatus 10 can include a lower frame 12 or base 12, a plurality of supports 14 coupled with the lower frame 12, and an upper frame 16 supported on the supports 14 above the lower frame 12. In some contemplated embodiments, the supports 14 can be lift mechanisms 14 that can move the upper frame 16 with respect to the lower frame 12. Also, in some contemplated embodiments, the person-support apparatus 10 can support a person-support surface 18 thereon.

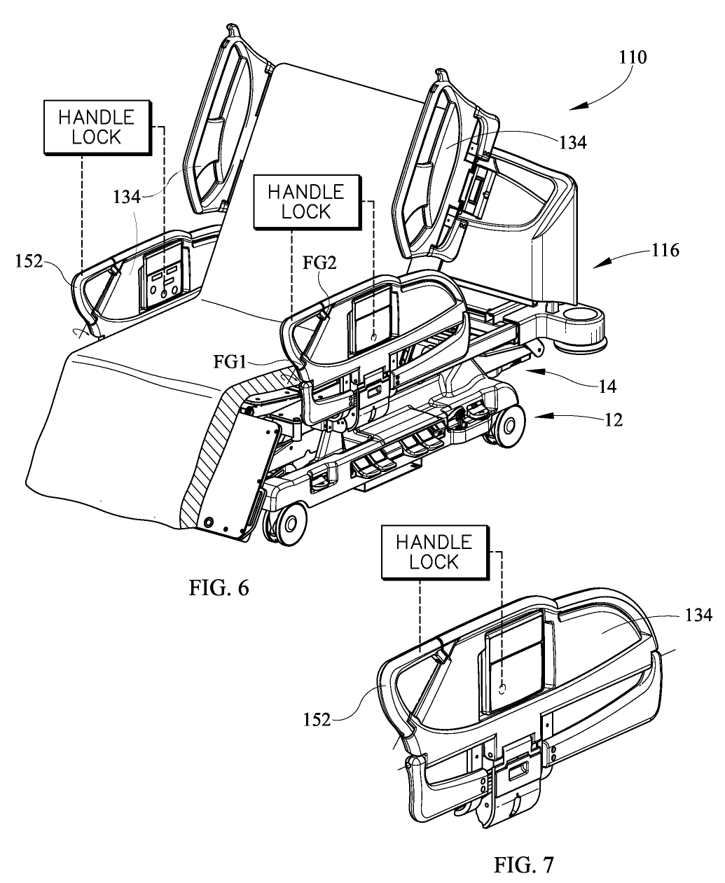

The upper frame 16 can include an upper frame base 20, a deck 22, siderails 24, and indicators 26 as shown in FIGS. 1-2 and 5. In some contemplated embodiments, the upper frame 16 can also include endboards EB1, such as, for example, a headboard HB1 and a footboard FB1, coupled to the first section F1 and the second section S1 of the person-support apparatus that, along with the siderails 24, can be perimeter locating structures that locate the perimeter or edge of the upper frame 16. The upper frame base 20 can be coupled with the supports 14 and can support the deck 22 thereon as shown in FIGS. 1-2 and 5. In one illustrative embodiment, the upper frame base 20, the supports 14, and the deck 22 can be configured to cooperate with one another to move the deck 22 between a relatively horizontal position and a chair position as shown in FIG. 6.

The deck 22 can include a head portion 28, a seat portion 30, and a foot portion 32 as shown in FIGS. 1-2 and 5. The head portion 28, the seat portion 30, and the foot portion 32 can be movably coupled with each other and/or the upper frame base 20. The head portion 28, the seat portion 30, and the foot portion 32 can each include a first deck surface 34, a second deck surface 36, and third deck surface 38 or deck side surface 38 extending between the first deck surface 34 and the second deck surface 36. In one illustrative embodiment, the first deck surface 34 can be configured to support the person-support surface 18 thereon and the second deck surface 36 can be configured to be coupled to the upper frame base 20.

The siderails 24 can include a siderail body 40 with a top portion ST1 and a bottom portion SB1, and a siderail movement assembly 42 as shown in FIGS. 1-5. The siderail movement assembly 42 can be coupled to the bottom portion SB1 of the siderail body 40 and can couple the siderails 24 to the deck 22 and/or the upper frame base 20. In one illustrative embodiment, one siderail 24 can be coupled to the head portion 28 of the deck 22 (i.e., a head siderail 24a or headrail 24a) and another siderail 24 can be coupled to the foot portion 32 of the upper frame base 20 (i.e., a foot siderail 24b or footrail 24b) as shown in FIGS. 1-2 and 5.

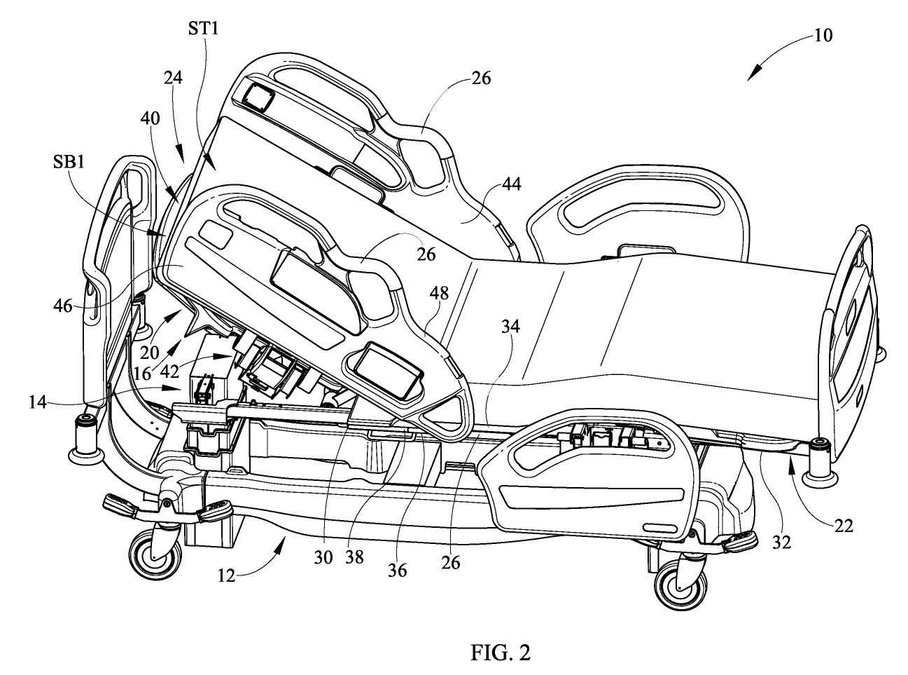

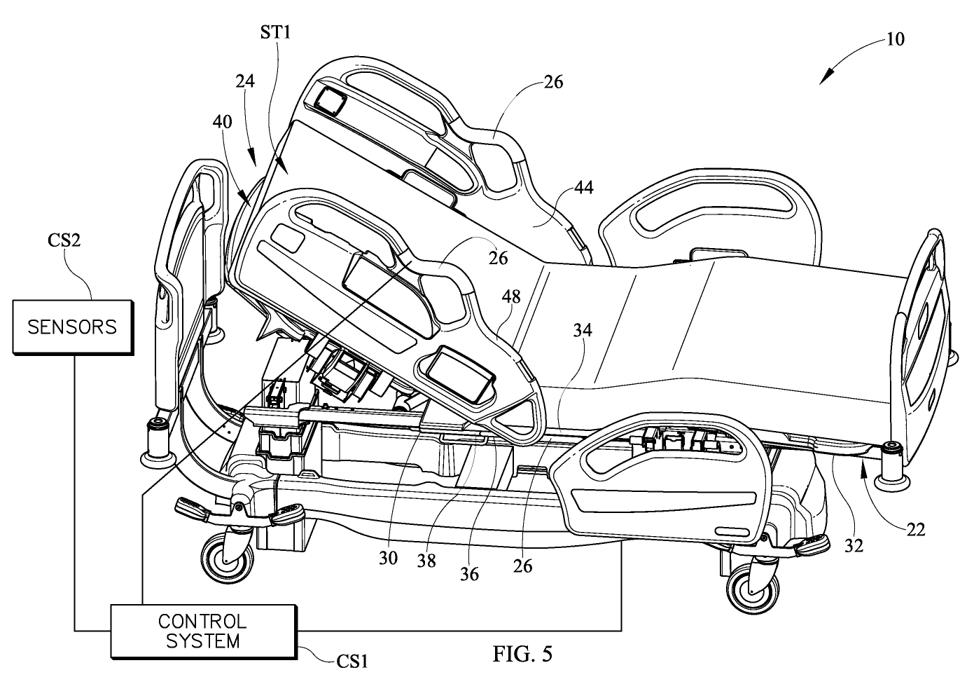

The siderail movement assembly 42 can be configured to can facilitate movement of the siderails 24 between a deployed position and a storage position. In the deployed position, as shown in FIG. 1, at least a portion of the siderail body 40 can be positioned above the upper frame 16. In the storage position, the siderail body 40 can be moved to a lower position where the siderail body 40 is below the deployed position as shown in FIGS. 2 and 5. The siderail movement assembly 42 can include a locking mechanism (not shown) that can maintain the siderails 24 in one of the deployed position and/or storage position when locked and can facilitate movement of the siderails 24 between the deployed and storage position when unlocked.

The siderail body 34 can include a first surface 44, a second surface 46, and a side surface 48 or perimeter edge 48 extending between the first surface 44 and the second surface 46, a grip portion 50 as shown in FIGS. 1-5. In some contemplated embodiments, the siderail 24 can include a caregiver interface (not shown) that can be operable to control various functionalities of the person-support apparatus 10. Also, in some contemplated embodiments, the headboard HB1 and the footboard FB1 can also include grip portions 48. At least a portion of the first surface 44 and the second surface 46 can be substantially parallel to one another. The first surface 44 can be oriented such that the first surface 44 faces toward the upper frame 16 and the second surface 46 can be oriented such that the second surface 46 faces away from the upper frame 16. The first surface 44 can be spaced apart from the second surface 46 and can cooperate with the second surface 46 and the side surface 48 to define an inner chamber 50.

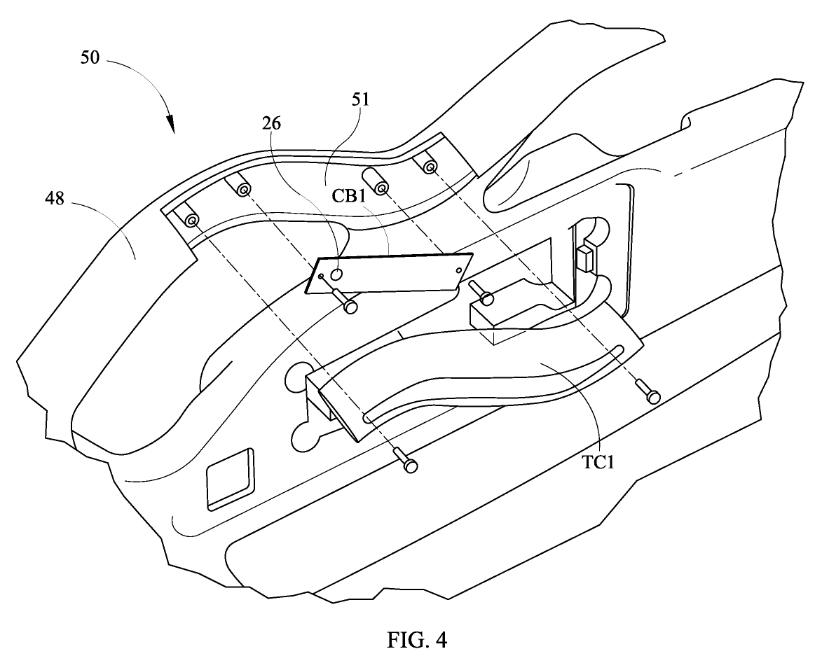

The grip portion 50 can be configured to be gripped by a person to assist the person with ingress/egress to/from the person support apparatus 10. The grip portion 50 can be located along the top portion ST1 and can include a grip 52 and a grip opening 54 as shown in FIGS. 1-5. In some contemplated embodiments, the grip portion 50 can be located along any portion of the siderail body 34 and/or endboards EB1. The grip opening 54 can pass through the siderail body 34 and can cooperate with the side surface 48 to define the grip 52. The upper portion of the grip opening 54 can define the bottom surface 56 of the grip 52 and the lower portion of the grip opening 54 can define an upper side surface 58 of the siderail body 34. In one illustrative embodiment, the grip 52 can include an inner grip chamber 51 that can contain an indicator 26 therein. In another illustrative embodiment, a portion of the grips 52 can include a translucent cover TC1 that can be coupled to the other portion of the grip 52 and can enclose a circuit board CB1 with an indicator 26 thereon in the inner grip chamber 51 as shown in FIG. 4.

In another illustrative embodiment of the current disclosure, the grip 152 can be pivotably coupled to the siderail body 134 at a first grip joint FG1 and a second grip joint FG2 and can be configured to move between a first position where the grip 152 can be used for ingress/egress to/from a side of the person-support apparatus 110, and a second position where the grip 152 can be configured to be pivoted in toward the upper frame 116 and used for ingress/egress to/from the person-support apparatus 110 when the person-support apparatus is in a chair configuration as shown in FIGS. 6-7. In some contemplated embodiments, a lock (not shown) can be configured to selectively maintain the grip 152 in the first position and/or second position.

The indicators 26 can be configured to identify features, functionalities, and/or status of the person-support apparatus 10. In one illustrative embodiment, the indicators 26 can be configured to identify the location of specific ergonomic gripping points on the siderail 24 by illuminating the portion of the grip 52 as shown in FIGS. 1-7. In some contemplated embodiments, any grip 52 on person-support apparatus 10, including, but not limited to, the headboard HB1, footboard FB1, and/or siderail 24, can be identified by the indicators 26. In another illustrative embodiment, the indicators 26 can be configured to assist a person with locating the edge of the person support surface 18 positioned on the upper frame 16 by illuminating the deck side surface 38 of the seat portion 30 as shown in FIGS. 1-2 and 5. In some contemplated embodiments, the indicators 26 can be positioned within the any of the deck sections or coupled to a surface of the deck sections. In another illustrative embodiment, the indicators 26 can be configured to be illuminated to alert a person as to the status of the person-support apparatus 10. In another illustrative embodiment, the indicators 26 can be configured to alert a person positioned on the person-support apparatus 10 as to when the person-support apparatus 10 has finished moving from a generally horizontal position to a chair position by illuminating a portion of the grips 152. In some contemplated embodiments, the indicators 26 can be controlled by a control system CS1 that can cause the indicators 26 to flash as the person-support apparatus 10 moves from the generally horizontal position toward the chair position. In some contemplated embodiments, the indicators 26 can not illuminate the grips 52 until the person-support apparatus 10 is in the chair position and the grips 152 are pivoted to the ingress/egress position. In another illustrative embodiment, the indicators 26 can be configured to be activated when the head portion 28 of the deck 22 is at a predetermined angle of inclination, such as, for example, 30°, with respect to the upper frame base 22. In other illustrative embodiments, the indicators 26 can be configured to identify various pedals PD1, handles LH2, user interface buttons UB1 and/or other portions of the person-support apparatus 10.

The indicators 26 can be a light source and/or a photo luminescent material or substance. In one illustrative embodiment, the indicators 26 can be light emitting diodes (LED's) positioned in the inner grip chamber 50. In some contemplated embodiments, the LED's can be molded into the grip 52. It should also be appreciated that the grip 52 can include a recessed portion that an LED strip can be positioned in. It should also be appreciated that the grip 52 can be molded separately from the siderail body 34 to include the indicators 26 and can be later coupled to the siderail body 34. In another illustrative embodiment, the indicators 26 can be photo luminescent paint and/or ink that can be incorporated into labels, control button overlays, or user interfaces, or applied to the grips 52.

The indicators 26 can be configured to identify the features, functionalities, and/or status of the person-support apparatus 10 when the ambient light in the room that the person-support apparatus 10 is in is below a predetermined threshold. It should also be appreciated that the indicators 26 can be configured to identify the features and/or functionalities of the person-support apparatus 10 regardless of the amount of ambient light in the room that the person-support apparatus 10 is in is. In some contemplated embodiments, the control system CS1 can receive input from a sensor CS2, such as, for example, a photoelectric sensor or inclinometer, and can cause the indicators 26 to illuminate as a function of the input from the sensors CS2 as shown in FIG. 5. In some contemplated embodiments, the control system CS1 can be configured to cause the indicators 26 to flash to indicate when the person-support apparatus 10 is performing a function, such as, articulating from the generally horizontal position to the chair position.

Many other embodiments of the present disclosure are also envisioned. For example, a siderail assembly comprises a siderail body and an indicator. The siderail body includes a first surface, a second surface, a side surface extending between the first surface and the second surface, and a grip portion. The grip portion includes a grip opening that cooperates with the side surface to define a grip. The indicator is configured to illuminate a portion of the grip.

In another example, a person-support apparatus comprises a frame, a deck, and an indicator. The deck is supported on the frame. The indicator is coupled to the deck and configured to illuminate the edge of the deck.

In another example, a person-support apparatus comprises a frame, a pedal, and an indicator. The pedal is movably coupled to the frame. The indicator is coupled to the pedal and configured to illuminate the pedal.

In another example, a person-support apparatus comprises a lower frame, a plurality of supports, an upper frame, a siderail, and an indicator. The upper frame is supported on the supports above the lower frame. The upper frame is configured to move between a substantially planar position and a chair position. The siderail is coupled to the upper frame and includes a grip portion with a grip. The indicator is coupled to the grip and is configured to illuminate the grip.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A siderail assembly, comprising:
a siderail body including a handle configured to be gripped by a person; and
an indicator configured to emit light to identify the location of the handle.

2. The siderail assembly of claim 1, wherein the indicator includes a light emitting diode.

3. The siderail assembly of claim 1, wherein the indicator includes a phosphorescent material.

4. The siderail assembly of claim 1, wherein the indicator is positioned within at least one of the siderail body and the handle.

5. The siderail assembly of claim 1, wherein the handle includes a substantially translucent portion.

6. The siderail assembly of claim 1, wherein the indicator is coupled proximate to the handle.

7. The siderail assembly of claim 1, wherein the handle is pivotably coupled to the siderail body and is configured to be movable between a first position and a second position.

8. The siderail assembly of claim 1, wherein the indicator is configured to be activated in low light conditions.

9. A person-support apparatus, comprising:
a frame;
a deck supported on the frame; and
an indicator coupled to the deck and configured to emit light to identify the location of a portion of the deck.

10. The person-support apparatus of claim 9, wherein the indicator is configured to be activated in low light conditions.

11. The person-support apparatus of claim 9, wherein the indicator is coupled to a seat portion of the deck.

12. The person-support apparatus of claim 9, wherein the indicator is configured to illuminate an edge of the deck.

13. The person-support apparatus of claim 9, wherein the deck includes at least one section with a first surface, a second surface, and a side surface extending between the first surface and the second surface, the indicator being coupled to the side surface.

14. A person-support apparatus, comprising:
a frame;
a pedal movably coupled to the frame; and
an indicator configured to emit light to identify the location of the pedal.

15. The person-support apparatus of claim 14, wherein the indicator is coupled to the pedal and emits light when the ambient light is below a predetermined threshold.

16. A person-support apparatus, comprising:
a lower frame;
a plurality of supports;
an upper frame supported on the supports above the lower frame, the upper frame being configured to move between a substantially planar position and a chair position;
an perimeter locating structures coupled to the upper frame and including a handle; and
an indicator coupled to the perimeter locating structures and configured to emit light to identify the location of the handle.

17. The person-support apparatus of claim 16 further comprising an input device, wherein the indicator emits light as a function of an input received by the input device.

18. The person-support apparatus of claim 17, wherein the input signal corresponds to an amount of light in a room.

19. The person-support apparatus of claim 17, wherein the upper frame includes a first portion and a second portion configured to move with respect to the first portion between a first position where the first portion and the second portion are substantially co-planar and an inclined position where the second portion is at an angle with respect to the first portion, the input signal corresponds to an angle of inclination of the second portion with respect to the first portion.

20. The person-support apparatus of claim 16, wherein the indicator is also configured to emit light to indicate a status of the person support apparatus.

21. The person-support apparatus of claim 20, wherein the indicator emits light according to a predetermined pattern to indicate when the person support apparatus is in the chair position.

22. The person-support apparatus of claim 16, wherein the handle is movably coupled to the perimeter locating structures and is illuminated by the indicator in a first position and not illuminated in a second position.

23. The person-support apparatus of claim 16, wherein the perimeter locating structures include at least one of a siderail and an endboard.
